(19) United States
(12) Patent Application Publication
(10) Pub. No.: US 2015/0220374 A1
(43) Pub. Date: Aug. 6, 2015

(54) INFORMATION PROCESSING APPARATUS, INFORMATION PROCESSING METHOD, AND COMPUTER-READABLE RECORDING MEDIUM

(71) Applicants: Taiki TSUZUKI, Kanagawa (JP); Hideaki FURUKAWA, Kanagawa (JP); Naoki HADACHI, Kanagawa (JP); Shingo YAMAZAKI, Kanagawa (JP)

(72) Inventors: Taiki TSUZUKI, Kanagawa (JP); Hideaki FURUKAWA, Kanagawa (JP); Naoki HADACHI, Kanagawa (JP); Shingo YAMAZAKI, Kanagawa (JP)

(73) Assignee: RICOH COMPANY, LIMITED, Tokyo (JP)

(21) Appl. No.: 14/611,658

(22) Filed: Feb. 2, 2015

(30) Foreign Application Priority Data
Feb. 4, 2014 (JP) 2014-019664

(51) Int. Cl. G06F 9/54

(52) U.S. Cl. CPC G06F 9/541

(57) ABSTRACT

An information processing apparatus comprises: a first platform having a first application programming interface; a wrapper absorbing difference between the first application programming interface and a second application programming interface on a second platform having the second application programming interface; and an intermediate task capable of calling a system call of the first platform and a system call of the wrapper, wherein when the intermediate task makes communication with a first task that is a task generated on the first platform, the intermediate task uses the system call of the first platform, whereas when the intermediate task makes communication with a second task that is a task generated on the wrapper, the intermediate task uses the system call of the wrapper.

### CROSS-REFERENCE TO RELATED APPLICATIONS

The present application claims priority to and incorporates by reference the entire contents of Japanese Patent Application No. 2014-019664 filed in Japan on Feb. 4, 2014.

### BACKGROUND OF THE INVENTION

1. Field of the Invention

The present invention relates to an information processing apparatus, an information processing method, and a computer-readable recording medium having a computer program.

2. Description of the Related Art

In order to develop application programs (hereinafter, referred to as applications) operating on a computer platform such as an operating system (OS) and middleware, application programming interfaces (APIs) formed by directions, functions, protocols, and the like have been provided. Developers of the applications can call APIs corresponding to desired functions on the programs so as to mount the functions on the applications.

Various different computer platforms (hereinafter, referred to as platforms) are present in the world. There is a problem in that an application developed for a specific platform as it is cannot operate on another platform.

Any of the following two methods enables an application developed for a certain platform to operate on another platform. A first method is a method in which APIs that are called by the application are rewritten into APIs of an OS at a port destination. A second method is a method in which wrapper programs (hereinafter, referred to as wrappers) for converting APIs at a port source into APIs at a port destination are provided between the application and the OS at the port destination, and the APIs of the OS at the port destination are called through the wrappers.

In the case of the first method, the APIs of the OS at the port destination are called by the application directly, so that overhead is small and a memory capacity that is used is reduced. On the other hand, the application that has already operated on the OS at the port source is modified, resulting in a possibility that failure is mixed. Due to this, verification of the application is needed newly.

In the case of the second method, wrapper functions of converting the APIs of the OS at the port source into the APIs of the OS at the port destination are prepared, so that the application needs not to be modified. On the other hand, overhead at time of execution of the application becomes large and a memory capacity that is consumed is larger than that in the case of the first method. The application that has ever operated and has high reliability needs not to be changed, thereby easily specifying a problem place when failure is generated. Furthermore, it is sufficient that the wrapper for each API is prepared, thereby reducing the number of processes and enabling efficient porting in comparison with the case when using the first method in which all the APIs in the application are rewritten. For these reasons, the second method is used more frequently (for example, Japanese Patent Application Laid-open No. 2004-246690).

FIG. 9 is diagram for explaining actions of an existing wrapper.

As illustrated in a part A of FIG. 9, an application-A developed for a platform-A is created so as to be compatible with an API (API-A) for the platform-A, so that it can be executed on an OS (OS-A) of the platform-A.

When the application-A is ported into a platform-B as illustrated in a part B of FIG. 9, it is not compatible with an API (API-B) for the platform-B and the application-A cannot be executed.

For coping with this, as illustrated in a part C of FIG. 9, a library (API wrapper) for absorbing difference between the API-A and the API-B is provided on the platform-B so as to cause the application-A to link with the library. This enables the application-A to operate on the platform-B without modifying the application-A. In this manner, the API wrapper plays a role in absorbing difference of the APIs between two different platforms.

The above-mentioned existing API wrapper (hereinafter, referred to as the wrapper), however, has a problem in that a task generated by a system call (one type of the API) of the OS (OS-B) on the platform-B cannot call a system call of the wrapper for the following reason. That is, the wrapper prepares management information (task control block (TCB)) of the system call and a task generated by the system call of the wrapper comes with the management information of the system call of the wrapper whereas the task generated by the system call of the OS-B does not come with the management information of the system call of the wrapper.

In view of the above-mentioned problem, there is a need to enable a task generated by a system call of a first platform having a first API to call a system call generated by a wrapper absorbing difference between the first API and a second API on a second platform having the second API in an information processing apparatus including the first platform and the wrapper.

### SUMMARY OF THE INVENTION

It is an object of the present invention to at least partially solve the problems in the conventional technology.

According to the present invention, there is provided an information processing apparatus comprising: a first platform having a first application programming interface; a wrapper absorbing difference between the first application programming interface and a second application programming interface on a second platform having the second application programming interface; and an intermediate task capable of calling a system call of the first platform and a system call of the wrapper, wherein when the intermediate task makes communication with a first task that is a task generated on the first platform, the intermediate task uses the system call of the first platform, whereas when the intermediate task makes communication with a second task that is a task generated on the wrapper, the intermediate task uses the system call of the wrapper.

The present invention also provides an information processing method that is executed by an information processing apparatus including a first platform having a first application programming interface, and a wrapper absorbing difference between the first application programming interface and a second application programming interface on a second platform having the second application programming interface, the information processing method comprising: making, by an intermediate task capable of calling a system call of the first platform and a system call of the wrapper, a first communication with a first task generated by the system call of the first platform using the system call of the first platform; and making, by the intermediate task, a second communication with a second task generated by the system call of the wrapper using the system call of the wrapper.

The present invention also provides a non-transitory computer-readable recording medium that contains a computer program that causes a computer to implement respective processes in the above-mentioned information processing method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an information processing apparatus according to an embodiment of the present invention;

FIG. 2 is a diagram illustrating a software group that is mounted on the information processing apparatus in the embodiment;

FIG. 3 is a diagram illustrating relations between tasks and system calls in the information processing apparatus in the embodiment;

FIG. 4 is a diagram for explaining actions of an intermediate task in the information processing apparatus in the embodiment;

FIG. 5 is a sequence diagram illustrating operations of the software group when the information processing apparatus in the embodiment receives print data;

FIG. 6 is a sequence diagram illustrating details of procedures at the time of wired communication of a print request to a job service proxy from a network component in FIG. 5;

FIG. 7 is a sequence diagram illustrating details of procedures at the time of wireless communication of the print request to the job service proxy from the network component in FIG. 5;

FIG. 8 is a sequence diagram for explaining relations between respective procedures in FIG. 7 and respective procedures in FIG. 4; and

FIG. 9 that includes parts A to C is diagram for explaining actions of a conventional wrapper.

### DETAILED DESCRIPTION OF THE PREFERRED EMBODIMENTS

Hereinafter, an embodiment of the invention will be described with reference to the drawings.

### Configuration of Information Processing Apparatus

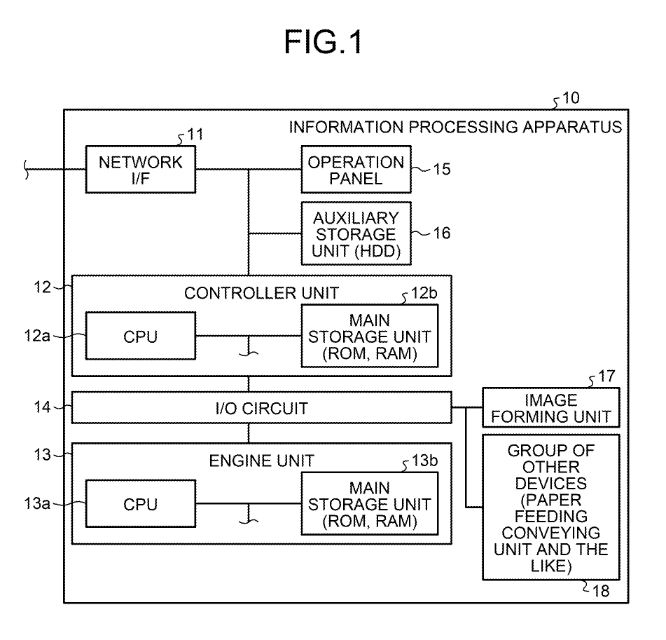

FIG. 1 is a block diagram of an information processing apparatus according to an embodiment of the invention. An information processing apparatus 10 is an image forming apparatus having a communication function and includes a network interface (I/F) 11, a controller unit 12, an engine unit 13, an I/O or input/output circuit 14, a display unit (operation panel) 15, an auxiliary storage unit (hard disk drive (HDD)) 16, an image forming unit 17, and a group of other devices (paper feeding conveying unit and the like) 18.

The network I/F 11 is an interface for transferring data between the information processing apparatus 10 and another communication apparatus connected to a network such as a public line including a local area network (LAN) and a wide area network (WAN) and a wireless line through the network.

The controller unit 12 causes a central processing unit (CPU) 12a as a controller control unit to execute programs for operating functions of the information processing apparatus 10 and controls overall operations of the information processing apparatus 10. A main storage unit 12b of the controller unit 12 includes a read only memory (ROM) and a random access memory (RAM) and programs for controlling the information processing apparatus 10 are stored in the ROM, for example. The programs for controlling overall the operations of the information processing apparatus 10 are loaded on the RAM and the CPU 12a executes the programs loaded on the RAM.

The engine unit 13 causes a CPU 13a as an engine control unit to control respective parts for operating an image formation function of the information processing apparatus 10. A main storage unit 13b of the engine unit 13 includes a ROM and a RAM. Programs stored in the ROM are loaded on the RAM and the CPU 13a executes the programs loaded on the RAM.

The I/O circuit 14 is an interface for transferring data among the controller unit 12, the engine unit 13, and respective parts that are controlled by them. The display unit 15 includes a display such as a liquid crystal display (LCD) and displays pieces of information of various types such as information related to a job and operation conditions and operation states of the information processing apparatus 10 on the display.

The auxiliary storage unit 16 is a hard disk drive (HDD) and stores therein pieces of information of various types and extended function programs that are used by the information processing apparatus 10, the OS as basic software, and the like. The image forming unit 17 is controlled by the CPU 13a of the engine unit 13, forms an image based on print information (print data) that has been image-processed by the controller unit 12, and prints it on print paper accommodated in a paper feeding cassette unit.

The group of other devices 18 includes the paper feeding cassette unit for accommodating pieces of print paper of various sizes, the paper feeding conveying unit that takes the print paper accommodated in the paper feeding cassette unit and conveys it to the image forming unit 17, a paper ejecting unit that ejects the print paper on which the image forming unit 17 has performed printing onto a paper ejection tray, and a driving unit that drives these units.

### Software Group

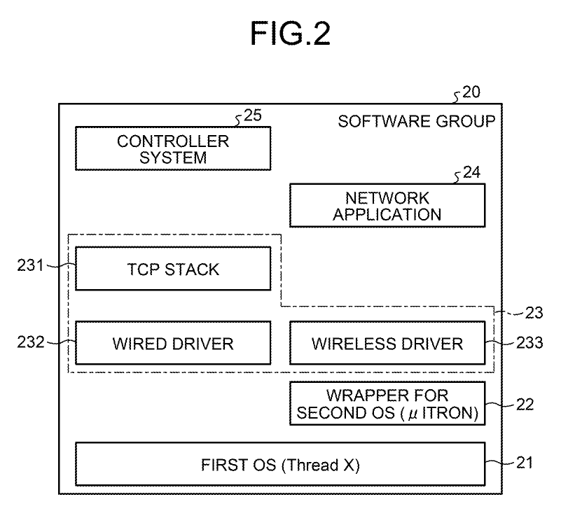

FIG. 2 is a diagram illustrating a software group that is mounted on the information processing apparatus 10. The auxiliary storage unit 16 holds a software group 20. The software group 20 is a program that the CPU 12a in the controller unit 12 uses.

As illustrated in FIG. 2, the software group 20 includes a first OS 21, a wrapper for a second OS 22, a network component 23, a network application 24, and a controller system 25. The first OS is Thread X (registered trademark) and the second OS is μITRON.

The network component 23 includes a transmission control protocol (TCP) stack 231, a wired driver 232, and a wireless driver 233. The TCP stack 231 is a program for executing a protocol of TCP communication through the network I/F 11. The wired driver 232 is a program for executing wired communication through the network I/F 11. The wireless driver 233 is a program for executing wireless communication through the network I/F 11.

The network application 24 includes a job service proxy and a network component control unit. The controller system includes applications such as a print application.

In the above-mentioned software group 20, the TCP stack 231 and the wired driver 232 that have operated on the second OS are ported so as to operate on the first OS 21. The wireless driver 233 and the network application 24 that have operated on the second OS are made to operate on the first OS 21 through the wrapper for the second OS 22. The controller system 25 that has operated on the first OS 21 is applied as it is.

That is to say, the TCP stack 231 and the wired driver 232 are ported into a first platform including the first OS from a second platform including the second OS. This measure is based on the existing first method. The wireless driver 233 and the network application 24 are ported into the first platform from the second platform through the wrapper for the second OS that absorbs difference between the APIs of the second OS and the APIs of the first OS. This measure is based on the existing second method.

### Task and System Call

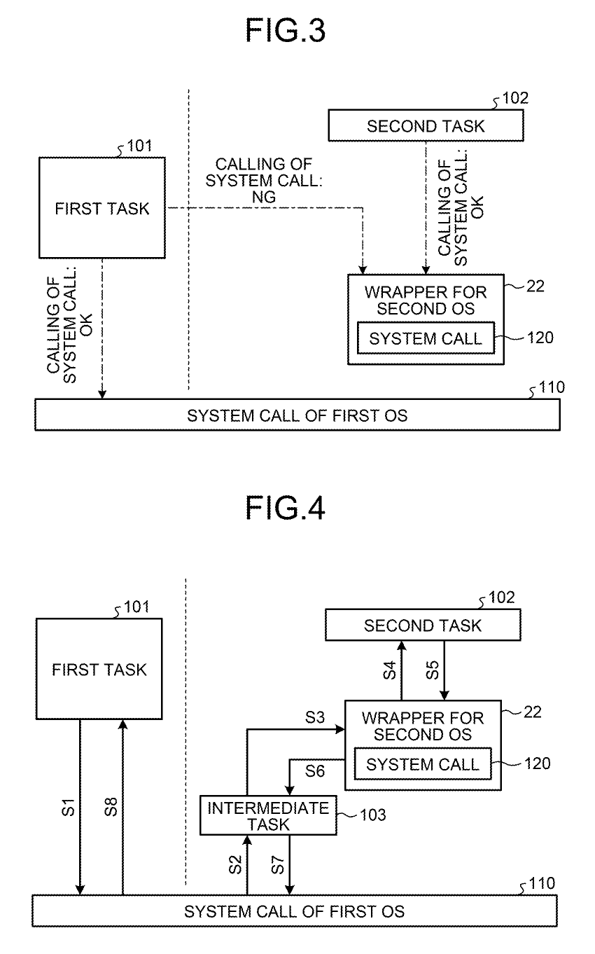

FIG. 3 is a diagram illustrating relations between tasks and system calls in the information processing apparatus 10. The system call is one type of the API. A first task 101 arranged at the left side with respect to a dashed line in FIG. 3 is a task generated by a system call 110 of the first OS 21. A second task 102 arranged at the right side with respect to the dashed line is a task generated by a system call 120 of the wrapper for the second OS 22.

The first task 101 can call the system call 110 of the first OS 21 but cannot call the system call 120 of the wrapper for the second OS 22 for the following reason. That is, the first task 101 comes with management information of the system call 110 of the first OS 21 but does not come with management information of the system call 120 of the wrapper for the second OS 22.

The management information of the system call 120 of the wrapper for the second OS 22 includes (i) a task ID (task identification number) that is assigned when a task is generated by the system call 120, (ii) a state of the task generated by the system call 120 (executing state, executable state, waiting state, or the like), and (iii) information of the first OS 21 (address, size, and the like of a memory for operation on the first OS 21), and the first task 101 does not have the pieces of information of (i) and (ii).

FIG. 3 is made to correspond to FIG. 2 as follows: Both of the wired driver 232 and the TCP stack 231 operate on the first OS 21, so that both of a task using the wired driver 232 and a task using the TCP stack 231 correspond to the first task 101. A task using the wireless driver 233 corresponds to the second task 102.

In order that the task using the TCP stack 231 makes task-to-task communication such as synchronization processing with the task using the wired driver 232, it is sufficient that it calls the system call 110 of the first OS 21. That is, the task-to-task communication can be executed.

On the other hand, in order that the task using the TCP stack 231 makes task-to-task communication with the task using the wireless driver 233, it needs to call the system call 120 of the wrapper for the second OS 22. That is, the task-to-task communication cannot be executed.

### Actions of Intermediate Task

In the information processing apparatus 10, an intermediate task enables the above-mentioned calling. The intermediate task is generated by the system call 120 of the wrapper for the second OS 22 and comes with the management information of the system call 110 of the first OS 21 in addition to the management information of the system call 120 of the wrapper for the second OS 22. With this, the intermediate task can call not only the system call 120 of the wrapper for the second OS 22 but also the system call 110 of the first OS 21. FIG. 4 is a diagram for explaining actions of the intermediate task in the information processing apparatus 10.

In order to transmit a message to the second task 102, the first task 101 calls and uses the system call 110 of the first OS 21 so as to transmit, to an intermediate task 103, a request for transmission of the message to the second task 102 (step S1).

The intermediate task 103 receives the request using the system call 110 of the first OS 21 (step S2). Next, the intermediate task 103 calls and uses the system call 120 of the wrapper for the second OS 22 in accordance with the received request so as to transmit the message from the first task 101 to the second task 102 (step S3).

The second task 102 receives the message from the first task 101 using the system call 120 of the wrapper for the second OS 22 (step S4) and transmits a result thereof to the intermediate task 103 (step S5). The intermediate task 103 receives the result from the second task 102 using the system call 120 of the wrapper for the second OS 22 (step S6).

Subsequently, the intermediate task 103 calls and uses the system call 110 of the first OS 21 so as to transmit the result from the second task 102 to the first task 101 (step S7). The first task 101 receives the result using the system call 110 of the first OS 21 (step S8).

Thus, the intermediate task 103 capable of calling the system call 110 and the system call 120 is provided. The intermediate task 103 is configured to use the system call 110 when it makes communication with the first task 101 and use the system call 120 when it makes communication with the second task 102. With this, the first task 101 can handle the call of the system call 110 and the call of the system call 120 in the same manner. That is to say, a task created by an OS can call a system call specific to another OS without any consideration, so that difference in changing programs created under environments of different OSs can be made smaller.

### Operations at the Time of Reception of Print Data

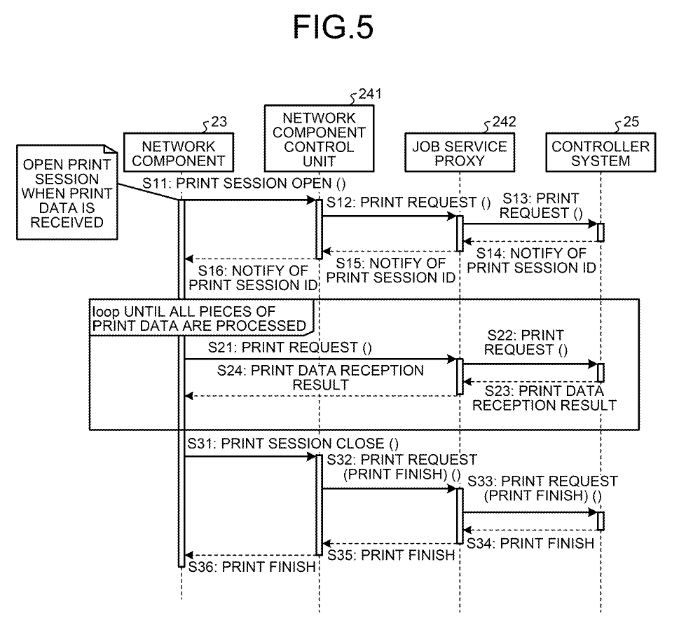

FIG. 5 is a sequence diagram illustrating operations of the software group 20 when the information processing apparatus 10 receives print data.

When the network component 23 (wired driver 232 or wireless driver 233) receives print data, it requests a network component control unit 241 to open a print session (step S11).

The network component control unit 241 transmits a “print request” to a job service proxy 242 (step S12). The job service proxy 242 transmits the “print request” to the controller system 25 (step S13).

The controller system 25 notifies the job service proxy 242 of a “print session ID” (step S14). The job service proxy 242 notifies the network component 23 of the “print session ID” through the network component control unit 241 (steps S15 and S16).

The network component 23 transmits a “print request” to the job service proxy 242 (step S21), and the job service proxy 242 transmits the “print request” to the controller system 25 (step S22). The controller system 25 transmits a “print data reception result” to the job service proxy 242 (step S23). The job service proxy 242 transmits the received “print data reception result” to the network component 23 (step S24). The pieces of processing at steps S21 to S24 are repeated until all the pieces of print data are processed.

The network component 23 requests the network component control unit 241 to close the print session when all the pieces of print data have been processed (step S31). The network component control unit 241 transmits a “print request (print finish)” to the job service proxy 242 (step S32). The job service proxy 242 transmits the “print request (print finish)” to the controller system 25 (step S33).

The controller system 25 notifies the job service proxy 242 of the “print finish” (step S34). The job service proxy 242 transmits the notification of the “print finish” to the network component 23 through the network component control unit 241 (steps S35 and S36).

### Details of Print Request Procedures at the Time of Wired Communication

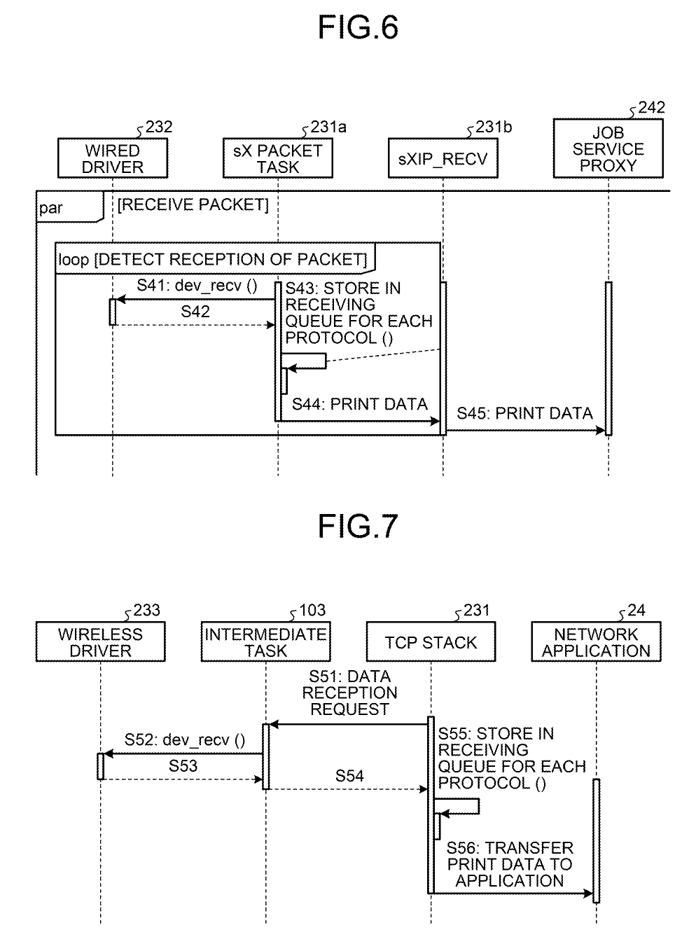

FIG. 6 is a sequence diagram illustrating details of procedures at the time of wired communication of a print request to the job service proxy from the network component in FIG. 5. The procedures are repeatedly executed while the wired driver 232 detects print data.

An sX packet task 231a as a task using the TCP stack 231 previously registers a function in the wired driver 232. When the wired driver 232 receives print data, it calls the function so as to notify the sX packet task 231a of the reception of the print data. The sX packet task 231a transmits “dev_recv( )” to the wired driver 232 (step S41). “dev_recv( )” is a function (system call) for requesting transmission of the print data from the wired driver 232 while a head address of a region storing therein packets of the print data is an argument.

The wired driver 232 transmits the print data to the sX packet task 231a as a response to “dev_recv( )” (step S42). The sX packet task 231a stores the received print data in a receiving queue for each of protocols (step S43). The protocols include a LPD protocol (print protocol), HTTPD (Web server protocol), and the like.

Thereafter, the sX packet task 231a transfers the print data to an sXIP_RECV 231b as a task using the TCP stack 231 (step S44). The sXIP_RECV 231b transfers the print data to the job service proxy 242 (step S45).

In the print request procedures at the time of the wired communication as described above, all the task using the wired driver 232, the sX packet task 231a, and the sXIP_RECV 231b are tasks (first tasks) generated by the system call 110 of the first OS 21. That is, the sX packet task 231a calls the system call 110 of the first OS 21 so as to perform synchronization processing with the task using the wired driver 232. It should be noted that the communication between the sX packet task 231a and the sXIP_RECV 231b (step S44) is not synchronization processing and does not involve calling of the system call.

### Details of Print Request Procedures at the Time of Wireless Communication

FIG. 7 is a sequence diagram illustrating details of procedures at the time of wireless communication of a print request to the job service proxy from the network component in FIG. 5. The procedures are repeatedly executed while the wireless driver 233 detects print data.

The TCP stack 231 (sX packet task 231a) transmits a “data reception request” to the intermediate task 103 (step S51). The intermediate task 103 transmits “dev_recv( )” to the wireless driver 233 based on reception of the “data reception request” (step S52).

The wireless driver 233 transmits the print data to the intermediate task 103 as a response to “dev_recv( )” (step S53). The intermediate task 103 receives the print data and transmits it to the TCP stack 231 as a response to the “data reception request” (step S54).

The TCP stack 231 stores the received print data in the receiving queue for each of the protocols (step S55) and transfers the print data to the network application 24 (step S56).

In the print request procedures at the time of the wireless communication as described above, the sX packet task 231a is a task (first task) generated by the system call 110 of the first OS 21 whereas the task using the wireless driver 233 is a task (second task) generated by the system call 120 of the wrapper for the second OS 22. For coping with this, the intermediate task 103 capable of calling the system call 110 of the first OS 21 and the system call 120 of the wrapper for the second OS 22 mediates the synchronization processing between the sX packet task 231a and the task using the wireless driver 233.

### Calling of System Call in Print Request Procedures at the Time of Wireless Communication

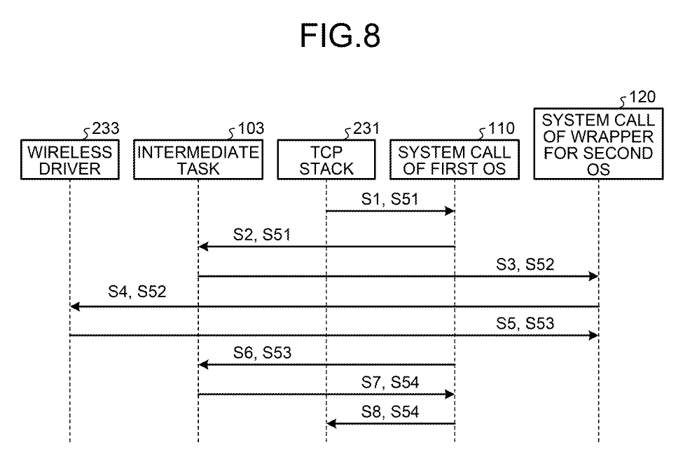

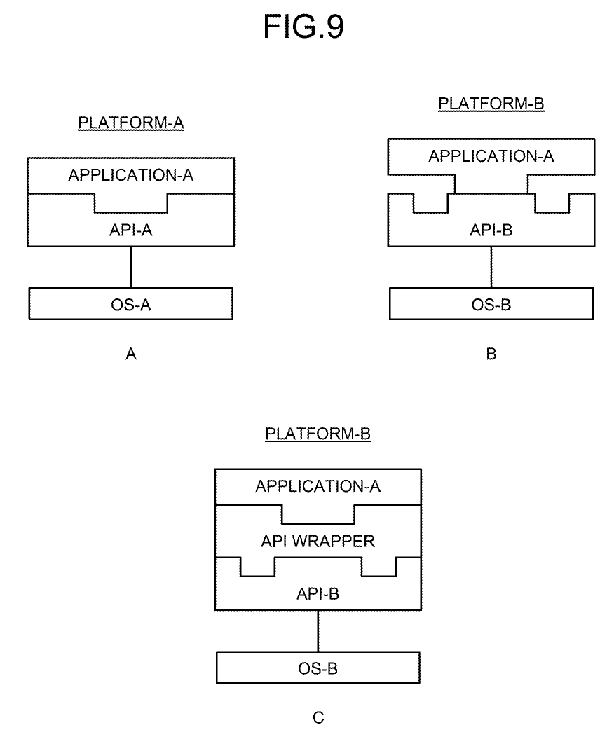

FIG. 8 is a sequence diagram for explaining relations between respective procedures in FIG. 7 and respective procedures in FIG. 4.

As illustrated in FIG. 8, in the communication procedures of the data reception request between the TCP stack 231 and the intermediate task 103 (step S51), the system call 110 of the first OS 21 is used (steps S1 and S2). In the communication procedures of the “dev_recv( )” between the intermediate task 103 and the wireless driver 233 (step S52), the system call 120 of the wrapper for the second OS 22 is used (steps S3 and S4). In the communication procedures of the print data between the wireless driver 233 and the intermediate task 103 (step S53), the system call 120 of the wrapper for the second OS 22 is used (steps S5 and S6). In the communication procedures of the print data between the intermediate task 103 and the TCP stack 231 (step S54), the system call 110 of the first OS 21 is used (steps S7 and S8).

The procedures at the time of the wired communication, the “wireless driver 233” in FIG. 8 is replaced by the “wired driver 232” and the “intermediate task 103” and the “system call 120 of the wrapper for the second OS 22” are removed. That is to say, procedures of “TCP stack 231”⇄the “system call 110 of the first OS 21”⇄“wired driver 232” are established.

The system call that is called in the information transfer at steps S51 to S54 (S1 to S8) in FIG. 8 will be described.

When information is transferred, one task calls a system call of “information waiting” and the other task calls a system call of “information transmission”. When the system call of “information waiting” is called, the system call interprets a “task ID” assigned when the task is generated and the fact that the task waits for the information is stored. Processing of the task that has called the system call is stopped until any information is received at the same time. Thereafter, when the system call of “information transmission” is called, the system call transmits information to the task in the state of “information waiting”.

When the task with no “task ID”, assigned when the task is generated, calls the system call of “information waiting”, the system call cannot interpret what task is to be made into the waiting state. For this reason, abnormality is determined immediately and the processing of the task cannot be stopped. Furthermore, the task that has called the system call of “information waiting” can no longer receive information because the processing of the task is not stopped.

Thus, with the information processing apparatus 10 according to the embodiment of the invention, the intermediate task 103 capable of calling the system call 110 of the first OS 21 and the system call 120 of the wrapper for the second OS 22 is provided, so that the first task 101 can handle calling of the system call 110 and calling of the system call 120 in the same manner. With this, the first task 101 can transmit a message for synchronization processing to the task (second task 102) generated by the system call 120 of the wrapper for the second OS 22.

According to the embodiment of the invention, a task generated by a system call of a first platform having a first API can call a system call generated by a wrapper absorbing difference between the first API and a second API on a second platform having the second API in an information processing apparatus including the first platform and the wrapper.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first platform having a first application programming interface;
a wrapper absorbing difference between the first application programming interface and a second application programming interface on a second platform having the second application programming interface; and
an intermediate task capable of calling a system call of the first platform and a system call of the wrapper, wherein
when the intermediate task makes communication with a first task that is a task generated on the first platform, the intermediate task uses the system call of the first platform, whereas when the intermediate task makes communication with a second task that is a task generated on the wrapper, the intermediate task uses the system call of the wrapper.

2. The information processing apparatus according to claim 1, wherein
the intermediate task includes:
a request receiving unit that receives a request transmitted using the system call of the first platform from the first task,
a communication unit that calls the system call of the wrapper in accordance with the received request and uses the system call so as to transmit the request and receive a result to and from the second task, and
a result transmission unit that calls the system call of the first platform and uses the system call so as to transmit the result to the first task.

3. The information processing apparatus according to claim 1, wherein
the intermediate task is a task generated by the system call of the wrapper.

4. An information processing method that is executed by an information processing apparatus including a first platform having a first application programming interface, and a wrapper absorbing difference between the first application programming interface and a second application programming interface on a second platform having the second application programming interface, the information processing method comprising:
making, by an intermediate task capable of calling a system call of the first platform and a system call of the wrapper, a first communication with a first task generated by the system call of the first platform using the system call of the first platform; and
making, by the intermediate task, a second communication with a second task generated by the system call of the wrapper using the system call of the wrapper.

5. A non-transitory computer-readable recording medium that contains a computer program that causes a computer to implement respective processes in the information processing method as claimed in claim 4.
